(19) United States
(12) Patent Application Publication
(10) Pub. No.: US 2012/0007337 A1
(43) Pub. Date: Jan. 12, 2012

(54) TRAILER HITCH

(76) Inventor: Joseph John McGinnes, New South Wales (AU)

(21) Appl. No.: 13/257,822

(22) PCT Filed: Mar. 4, 2010
(86) PCT No.: PCT/AU2010/000256

§ 371 Date: Sep. 20, 2011

(30) Foreign Application Priority Data
Mar. 20, 2009 (AU) 2009901198

(51) Int. Cl. B60D 1/01

(52) U.S. Cl. 280/456.1

(57) ABSTRACT

A trailer coupling (1) is disclosed having a first interconnection (2, 12) to a prime mover (4) and a second interconnection (14) to a trailer. A pivot mechanism which includes a universal joint (13) interconnects the first and second interconnections. The first interconnection is a frusto-conical spigot (2) and a frusto-conical sleeve housing (12). This interconnection is rigid and does not permit any movement between the prime mover and the sleeve housing (12). The universal joint (13) is rotatably mounted to permit movement between the trailer and the prime mover about a vertical axis (136), a left to right horizontal axis (137) and a front to rear horizontal axis (34).

### CROSS REFERENCE TO RELATED APPLICATIONS

This application is the U.S. National Stage of PCT Application Ser. No. PCT/AU2010/000256, filed on Mar. 4, 2010, which claims priority from Australian Patent Application Ser. No. 2009901198, filed on Mar. 20, 2009, both of which are incorporated by reference in their entireties.

### BACKGROUND OF THE INVENTION

The present invention relates to trailer hitches which are used to couple a prime mover (or towing vehicle) to a trailer (or towed vehicle).

Generally speaking, trailer hitches can be classified into three distinct types. One type of hitch is a turn-table hitch which is used for semi-trailers or articulated vehicles and is not of concern in relation to the present invention.

The next type of hitch consists of a donut shaped device (that is to say an anulus having a substantially circular cross-section) which is arranged in a generally horizontally plane and which is connected by means of a vertical post of cylindrical cross-section (or pintle). The vertical post bearing on the inner most diameter provides the left or right turning ability, whilst the vertical post moving on the inner curve of the donut provides the ability for the prime mover and the trailer to travel over humps and across dips. This hitch suffers from two distinct disadvantages in that, firstly, it is not able to cater for the prime mover being on a piece of ground which slopes from high ground on the left to low ground of the right, whilst the trailer stands on ground which slopes from the high ground on the right to low ground on the left. Secondly, every time the towing vehicle brakes or accelerates, there is an unrestrained backwards and forwards motion of the trailer which results in the vertical post hitting either the leading interior edge or the trailing interior edge of the donut.

The third type of prior art hitch takes the form of a substantially cylindrical ball which is mounted on the top of an upright support, and which receives a substantially hemispherical cup. The hemispherical cup is able to rotate about three axes of rotation relative to the center of the sphere, however, the extent of the rotation is limited because of a locking mechanism which holds the cup to the sphere. This locking mechanism involves prongs or fingers which come together under the “equator” of the sphere and thus retain the cup on the sphere.

All three of these prior art devices are characterized in that the point of interconnection between the trailer coupling and the prime mover or towing vehicle is also the location of the pivoting mechanism which enables the trailer to pivot relative to the prime mover. This has the consequence that the point of interconnection between the trailer coupling and the prime mover is also the site of wear through use. An extremely dangerous consequence of this wear is that the trailer coupling may detach from the prime mover under load, particularly as a consequence of a sudden shock caused by a bump or similar. This has the extremely dangerous consequence that the trailer detaches from the prime mover and may well cause the prime mover to have an accident.

The genesis of the present invention is a desire to provide a trailer coupling where the point of attachment between the prime mover and the trailer coupling is physically spaced from the pivoting mechanism which permits the trailer to pivot relative to the prime mover, and/or where the interconnection between the trailer coupling and the prime mover is substantially rigid and thus not subjected to wear.

### SUMMARY OF THE INVENTION

In accordance with a first aspect of the present invention there is disclosed a trailer coupling having a first interconnection between a prime mover and said coupling, a second interconnection between said coupling and a trailer, and a pivot mechanism to permit said trailer to pivot relative to said prime mover, wherein said pivot mechanism is located intermediate said first and second interconnections and spaced from said first interconnection.

In accordance with a second aspect of the present invention there is disclosed a trailer coupling for connecting a prime mover to a trailer and having a first interconnection between said prime mover and said coupling, wherein said first interconnection does not permit movement between said prime mover and said trailer coupling.

In accordance with a third aspect of the present invention there is also disclosed a method of interconnecting a prime mover with a trailer using a trailer coupling, said method comprising the steps of: (i) making a first interconnection between said prime mover and said coupling, (ii) making a second interconnection between said trailer and said coupling, (iii) locating a pivot mechanism between said first and second interconnections, and (iv) spacing said pivot mechanism from said first interconnection.

In accordance with a fourth aspect of the present invention there is also disclosed a method of interconnecting a prime mover to a trailer using a trailer coupling, said method comprising the steps of: (a) making a first interconnection between said prime mover and said trailer coupling, and (b) making said first interconnection rigid to thereby prevent movement between said prime mover and said trailer coupling.

### BRIEF DESCRIPTION OF THE DRAWINGS

Preferred embodiments of the invention will now be described, by way of example only, with reference to the accompanying drawings in which:

FIG. 1 is an exploded side view of the trailer hitch of a first embodiment,

FIG. 2 is a vertical cross-section taken through the assembled spigot and frusto-conical housing of FIG. 1,

FIG. 3 is a perspective view from above and to one side of the trailer coupling of a second embodiment, and

FIG. 4 is a side view of the spigot and locking cap of the trailer coupling of FIG. 3.

### DETAILED DESCRIPTION OF THE PREFERRED EMBODIMENTS

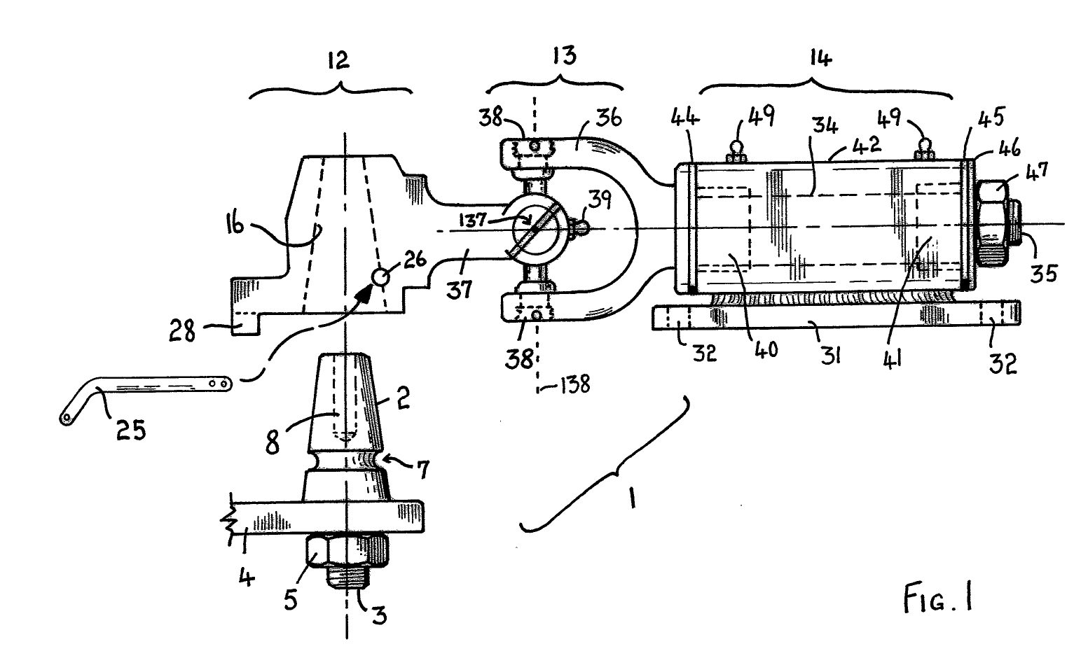

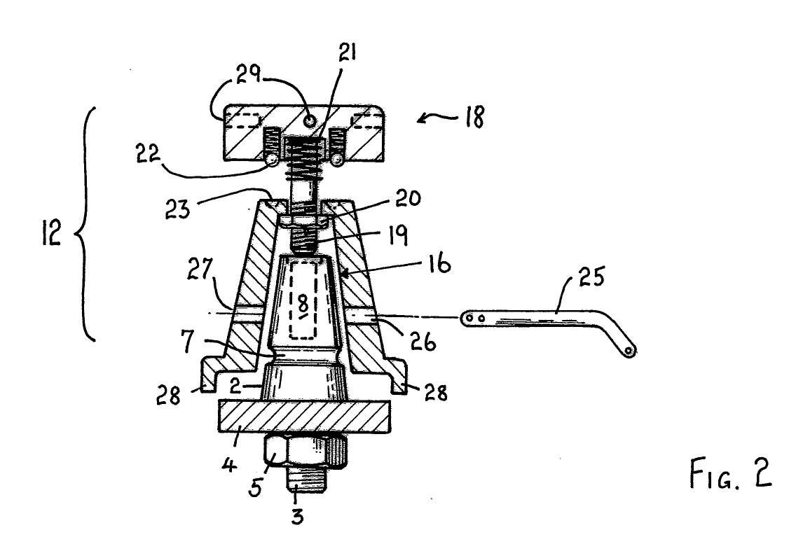

As seen in FIGS. 1 and 2, the trailer coupling 1 of a first embodiment is illustrated and takes the form of a spigot 2 which has a threaded shank 3 which passes through an aperture in a towbar or goose neck 4 which is part of a prime mover (not illustrated). The spigot 3 is secured to the goose neck 4 by means of a nut 5. The spigot 2 is of frusto-conical shape and has a circumferential groove 7 and a threaded blind hole 8 in its upper end.

The portion of the trailer coupling 1 which connects to the trailer (not illustrated) takes the form of a sleeve housing 12, a universal joint 13 and a trailer coupling 14.

The sleeve housing 12 has an interior frusto-conical cavity 16 which is capable of mating with the spigot 12. As illustrated in FIG. 2, the housing 12 includes a locking cap 18 having a threaded shank 19 which is dimensioned to be received by the threaded blind hole 8 in the spigot 2. The locking cap 18 also includes a lock nut 20 and a pair of detents 22 which mate with corresponding recesses 23 in the top of the sleeve housing 12.

A spring 21 surrounds the shank 19 and is compressed by the inter-engagement of the locking cap 18 and sleeve housing 12 to assist in maintaining the locking cap 18 securely placed in its final position.

With the spigot 2 secured to the goose neck 4, the sleeve housing 12 can be placed over the spigot 2 and moved downwardly so that the frusto-conical surfaces of the spigot 2 and cavity 16 inter-engage with each other. The locking cap 18 is then rotated so as to threadably engage the threaded shank 19 of the locking cap 18 with the threaded blind hole 8 of the spigot 2, the locking cap 18 being maintained in position by the inter-engagement of the detents 22 and the recesses 23. The locking cap 18 is preferably provided with radial apertures 29 into which a locking pin 25 can be inserted. In this way, the locking pin 25 can be used as a lever to provide extra force to rotate the locking cap 18.

In addition, the locking pin 25 is thereafter passed through a pair of apertures 26, 27 in the sleeve housing 12 so as to thereby retain the locking pin 25 in the circumferential groove 7. The locking pin 25 can be secured by any convenient means such as a spring clip or cotter pin (not illustrated in FIG. 2).

Preferably the sleeve housing 12 is provided with a pair of downwardly directed lugs 28 which are spaced to provide a close fit to either side of the goose neck or towbar 4 and are a further preventative mechanism to prevent rotation of the sleeve housing 12 relative to the spigot 2.

Returning now to FIG. 1, the trailer coupling 14 takes the form of a connector plate 31 which includes apertures 32 which enable the trailer coupling 14 to be bolted to a corresponding plate (not illustrated but conventional) mounted at the apex of the trailer yoke. The trailer coupling 14 also has a longitudinal axle 34 which is threaded at its rear end 35 and provided with a pair of Y-shaped arms 36 at its leading end. The Y-shaped arms 36 form part of a substantially conventional universal joint 13 which is provided with a grease nipple 39.

The longitudinal axle 34 is mounted within a pair of bushings 40, 41 located within a hollow cylinder 42 which is welded to the connector plate 31. Two polyurethane washers 44, 45 are located at opposite ends of the hollow cylinder 42 and a metal washer 46 and nut 47 are mounted on the rear end 35 of the axle 34. The nut 47 compresses the polyurethane washers 44 and 45 and provides a sealed space which can be filled with grease via grease nipples 49. The bushings 40, 41 each have an interior aperture which is cylindrical and an exterior shape which is substantially rectangular to thereby ensure that the bushings 40, 41 do not themselves rotate but instead the axle 34 rotates within the bushings 40, 41.

The universal joint 13 is entirely conventional in construction having two pairs of Y-shaped arms 36, 37 (only one of the Y-shaped arms 37 being illustrated in FIG. 1). The free ends of the Y-shaped arms 36, 37 carry threaded plugs 38 which retain the internal universal joint mechanism. Extending between the Y-shaped arms 36 is a vertical axis 136 which enables the prime mover to turn from left to right and the trailer coupling 1 to pivot about the vertical axis 136 as the trailer follows the left or right movements of the prime mover.

In addition, extending between the Y-shaped arms 37 is a substantially horizontal axis 137. The pivoting movement of the universal joint 13 about the horizontal axis 137 enables the prime mover to pass over dips and bumps and have the trailer follow faithfully behind. Furthermore, the extent of angular movement about the vertical axis 136 and the horizontal axis 137 typically exceeds approximately 210 degrees so in respect of these two pivoting movements the trailer coupling 1 is far superior to any of the prior art types of trailer coupling.

Furthermore, the longitudinal axis 34 constitutes a front to rear axis about which the trailer is able to pivot relative to the prime mover. This enables the prime mover to be positioned on ground which slopes, for example, from high ground on the left to low ground on the right whereas the trailer can be positioned on ground which slopes in the opposite direction namely from tow ground on the left to high ground on the right. Such pivoting movement is not provided at all in the donut type prior art trailer coupling and is only provided to a limited extent in the spherical ball and hemispherical cap type of prior art trailer coupling, because of the need for the cap to be secured to the ball. However, in the arrangement illustrated in FIG. 1, essentially a 360 degree movement is possible although in practice movements of the order of less than 30 degrees are to be expected.

It will also be apparent that longitudinal movement between the prime mover and the trailer occasioned by the prime mover accelerating and decelerating or braking is taken up by the ability of the polyurethane washers 44, 45 to be compressed and expand after being compressed.

Furthermore, upward or downward loads of the trailer on the prime mover (caused by the trailer load center of gravity being respectively behind or in front of the trailer ground engaging wheels) are resisted by the 2 and sleeve housing 12.

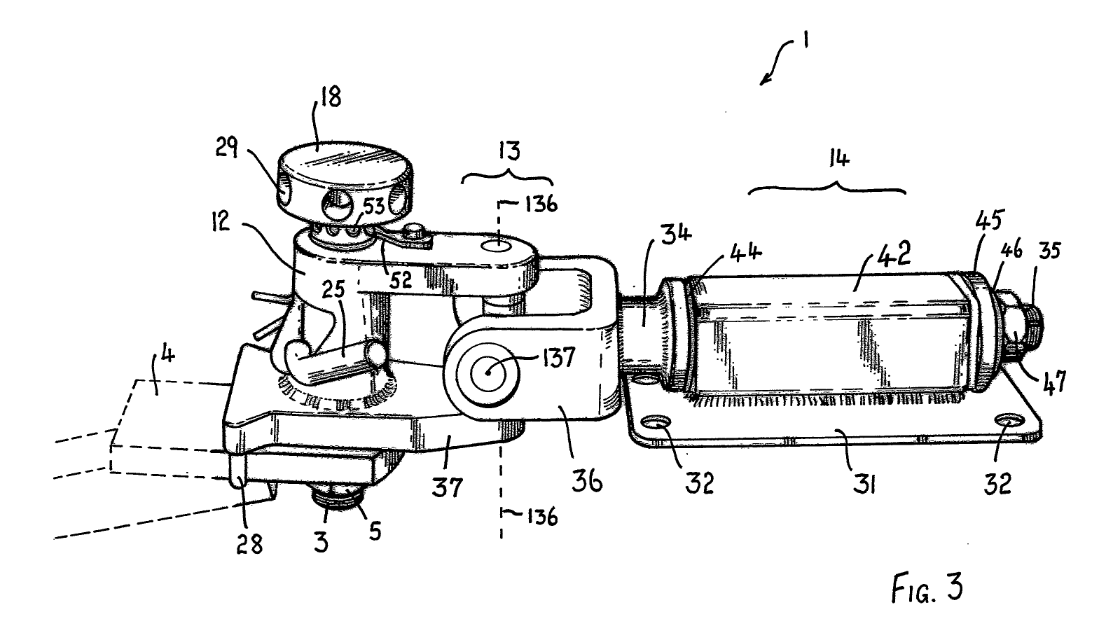

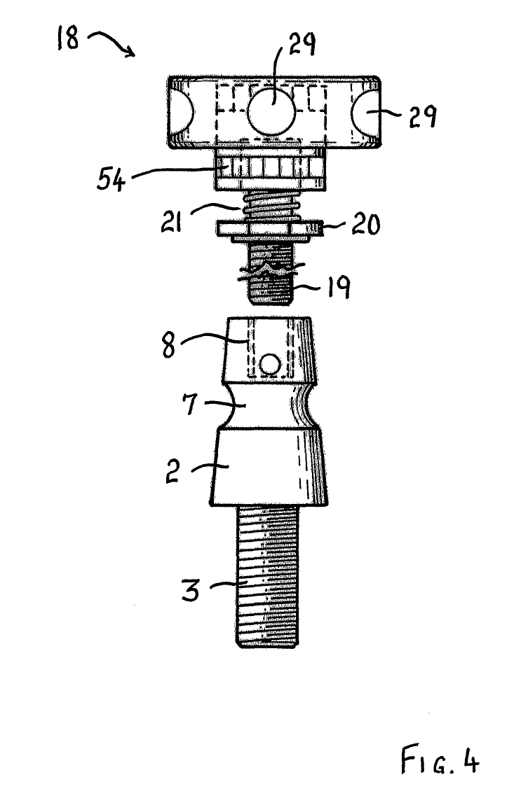

Turning now to FIGS. 3-4, a second embodiment of the present invention is illustrated in which like parts to those of the first embodiment are designated by the same number.

It will be seen from FIG. 3 that the locking cap 18 instead of being provided with detents 22 is provided with a ratchet and pawl mechanism in which the pawl 52 mates with recesses 53 in the locking cap 18. Alternatively, as illustrated in FIG. 4, the locking cap 18 instead of being provided with recesses 53 can be provided with a series of ramps 54 which engage the pawl 52.

The foregoing describes only two embodiments of the present invention and modifications, obvious to those skilled in the motor vehicle arts, can be made thereto without departing from the scope of the present invention.

The term “comprising” (and its grammatical variations) as used herein is used in the inclusive sense of “including” or “having” and not in the exclusive sense of “consisting only of”.

1. A coupling having a first interconnection between a prime mover and said coupling, a second interconnection between said coupling and a trailer, and a pivot mechanism to permit said trailer to pivot relative to said prime mover, wherein said pivot mechanism is located intermediate said first and second interconnections and is spaced from said first interconnection.

2. The coupling as claimed in claim 1 wherein said first interconnection between said prime mover and said coupling does not permit movement between said prime mover and said coupling.

3. A coupling for connecting a prime mover to a trailer and having a first interconnection between said prime mover and said coupling, wherein said first interconnection does not permit movement between said prime mover and said coupling.

4. The coupling as claimed in claim 3 and having a second interconnection between said coupling and said trailer, and a pivot mechanism to permit said trailer to pivot relative to said prime mover, wherein said pivot mechanism is located intermediate said first and second interconnections and is spaced from said first interconnection.

5. The coupling as claimed in claim 1 wherein said pivot mechanism comprises a universal joint.

6. A coupling as claimed in claim 5 wherein said first interconnection comprises a spigot able to be coupled to said prime mover in an upright position, and a sleeve housing having a sleeve engageable with said spigot.

7. The coupling as claimed in claim 6 wherein said spigot and said sleeve are substantially frusto-conical.

8. The coupling as claimed in claim 6 wherein said spigot and said sleeve housing include a releasable retention means.

9. The coupling as claimed in claim 8 wherein said retention means comprises a circumferential groove in said spigot and a pin which passes through said sleeve and engages with said groove.

10. The coupling as claimed in claim 8 wherein said retention means comprises a locking cap on said sleeve housing which threadably engages said spigot.

11. The coupling as claimed in claim 6 wherein said spigot has a threaded shank dimensioned to connect with a towbar of said prime mover.

12. The coupling as claimed in claim 6 wherein said trailer connector comprises a hollow cylinder having a longitudinal axis and which is able to be mounted on a front-to-rear longitudinal axis of said trailer, an axle extending within said cylinder, and rotatable about said cylinder longitudinal axis, having said universal joint connected to a front end of said axle, and having an axle retaining means at a rear end of said axle.

13. The coupling as claimed in claim 12 wherein said axle retaining means comprises a washer having an outer diameter exceeding an internal diameter of said hollow cylinder, said rear end of said axel being threaded, and a nut engaged with said rear end of said axle and urging said washer towards said cylinder.

14. A method of interconnecting a prime mover with a trailer using a coupling, said method comprising the steps of:
(a) making a first interconnection between said prime mover and said coupling,
(b) making a second interconnection between said trailer and said coupling,
(c) locating a pivot mechanism between said first and second interconnections, and
(d) spacing said pivot mechanism from said first interconnection.

15. The method as claimed in claim 14 including the further step of:
(v) making said first interconnection rigid to thereby prevent movement between said prime mover and said coupling.

16. The method as claimed in claim 14 including the further step of:
(vi) selecting said pivot mechanism to be a universal joint.

17. A method of interconnecting a prime mover to a trailer using a coupling, said method comprising the steps of:
(a) making a first interconnection between said prime mover and said coupling, and
(b) making said first interconnection rigid to thereby prevent movement between said prime mover and said coupling.

18. The method as claimed in claim 17 including the further steps of:
(c) making a second interconnection between said trailer and said coupling,
(d) locating a pivot mechanism between said first and second interconnections, and
(e) spacing said pivot mechanism from said first interconnection.

19. The method as claimed in claim 18 including the further step of:
(f) selecting said pivot mechanism to be a universal joint.

20. The coupling as claimed in claim 3 wherein said pivot mechanism comprises a universal joint.

21. A coupling as claimed in claim 20 wherein said first interconnection comprises a spigot able to be coupled to said prime mover in an upright position, and a sleeve housing having a sleeve engageable with said spigot.

22. The coupling as claimed in claim 21 wherein said spigot and said sleeve are substantially frusto-conical.

23. The coupling as claimed in claim 21 wherein said spigot and sleeve housing include a releasable retention means.

24. The coupling as claimed in claim 23 wherein said retention means comprises a circumferential groove in said spigot and a pin which passes through said sleeve an engages with said groove.

25. The coupling as claimed in claim 23 wherein said retention means comprises a locking cap on said sleeve housing which threadably engages said spigot.

26. The coupling as claimed in claim 21 wherein said spigot has a threaded shank dimensioned to connect with a towbar of said prime mover.

27. The coupling as claimed in claim 21 wherein said trailer connector comprises a hollow cylinder having a longitudinal axis and which is able to be mounted on a front-to-rear longitudinal axis of said trailer, an axle extending within said cylinder, and rotatable about said cylinder longitudinal axis, having said universal joint connected to a front end of said axle, and having an axle retaining means at a rear end of said axle.

28. The coupling as claimed in claim 27 wherein said axle retaining means comprises a washer having an outer diameter exceeding the internal diameter of said hollow cylinder, said rear end of said axle being threaded, and a nut engaged with said rear end of said axle and urging said washer towards said cylinder.
